(19) United States
(12) Patent Application Publication
(10) Pub. No.: US 2009/0131077 A1
(43) Pub. Date: May 21, 2009

(54) MULTIMODAL DATA COLLECTION DEVICE

(75) Inventors: Robert M. Paratore, Redmond, WA (US); Timothy Meese, Seattle, WA (US)

Correspondence Address: BLACK LOWE & GRAHAM, PLLC, 701 FIFTH AVENUE, SUITE 4800, SEATTLE, WA, 98104, US

(73) Assignee: Adapx, Inc., Seattle, WA (US)

(21) Appl. No.: 12/272,608

(22) Filed: Nov. 17, 2008

Related U.S. Application Data
(60) Provisional application No. 60/988,692, filed on Nov. 16, 2007.

(51) Int. Cl. H04M 1/00; H04W 24/00; H04B 7/00

(52) U.S. Cl. 455/456.1; 455/41.2; 455/556.2

(57) ABSTRACT

A multimodal data collection device uses a digital pen as a primary input mechanism for data and for controlling the device. The digital pen may be connected to the multimodal data collection device through a wired connection, a wireless host connection, or a slave connection. The multimodal data collection device receives data from a number of input/output devices, captures the data, and then synchronizes selected written, voice and image data with time stamp information and geospatial location information to re-create one or more pre-existing events. In addition, the multimodal data collection device operates to arrange externally and internally received data by synchronizing the data with time and location information.

### PRIORITY CLAIM

This application claims priority to U.S. Provisional Patent Application Nos. 60/988,692 (filed on Nov. 16, 2007), and of which the subject matter is incorporated herein by reference in its entirety.

### FIELD OF THE INVENTION

This invention relates generally to a data collection device for augmenting geospatial location and performing time synchronization with input from a digital pen device and possibly other external data input or collection devices, and more specifically a portable multimodal data collection device with geospatial location and time synchronization.

### BACKGROUND OF THE INVENTION

Conventional data collection devices may include, but are not limited to, personal digital assistants (PDAs), specialty bar code scanners, smart cellular phones, or laptop computers with the ability to execute third party software or proprietary programs.

One drawback with conventional data collection devices is their complex user interface (UI) combined with a steep learning curve. Also, many applications for data collection are still performed with pen and paper via forms for entry into log books. Data collected in this manner requires processing via optical character recognition (OCR) or manual input into enterprise back end systems.

Many users, such as field service workers, require data from multiple data collection devices for their data collection effort to capture even a single event. The data may be from mapping, construction or simple event data logging. The data must then be later interpreted using human intervention to transpose the information gathered in the field into existing back end systems databases or software applications. By way of example, one environment in which a user may employ multiple data collection devices involves the installation of a cable or pipeline. During the installation process, the workers may note new cable runs on charts or obsolete old runs, take pictures of the scene and note the geospatial location and time of the event, scan bar coded items and create logs and annotations. However, any subsequent updates or interpretation of the individually collected data is accomplished through manual operations.

### SUMMARY OF THE INVENTION

In one aspect of the invention, a multimodal data collection device includes a housing having a plurality of connectivity ports to connect the multimodal data collection device with at least one data input/output device located external to the housing; a microprocessor located within the housing and in communication with at least one memory; a global positioning system module located within the housing and in communication with the microprocessor, the global positioning system module including a semiconductor chip configured to cooperate with at least one global positioning system software application; a digital pen processing module located within the housing and in communication with the microprocessor, the digital pen processing module operable to receive and interpret digital pen input from a digital pen and paper system; and an audio module located within the housing and configured to receive voice commands and annunciate status information regarding the multimodal data collection device, the audio module in communication with the global positioning system module to receive global positioning system information at a commanded interval.

In another aspect of the invention, a method of collecting data using a multimodal data collection device includes the steps of (1) receiving data from a plurality of data input/output devices located external to a housing of the multimodal data collection device; (2) synchronizing the received data with a time and an amount of geospatial information corresponding to when the data was received; (3) storing the received data; and (4) using at least some of the stored data to reconstruct an event history for at least one event involving the plurality of data input/output devices.

### BRIEF DESCRIPTION OF THE DRAWINGS

Preferred and alternative examples of the present invention are described in detail below with reference to the following drawings:

FIG. 1 is a perspective view of a multimodal data collection device according to an embodiment of the present invention;

FIGS. 2A-2D are side elevational and plan views, respectively, of the multimodal data collection device of FIG. 1;

FIG. 3 is a schematic diagram showing a multimodal data collection device having communication interfaces with a plurality of input/output devices according to an embodiment of the present invention; and

FIG. 4 is a block diagram of the internal components of the multimodal data collection device of FIG. 1 according to an embodiment of the present invention.

### DETAILED DESCRIPTION OF THE PREFERRED EMBODIMENT

In the following description, certain specific details are set forth in order to provide a thorough understanding of various embodiments of the invention. However, one skilled in the art will understand that the invention may be practiced without these details or with various combinations of these details. In other instances, well-known systems and methods associated with, but not necessarily limited to, data collection devices, input/output (I/O) devices, memory systems, geographic positioning system chips and applications, geospatial information systems, Bluetooth devices, audio input and output devices, digital paper systems, digital pens and methods for operating the same may not be shown or described in detail to avoid unnecessarily obscuring descriptions of the embodiments of the invention.

The present invention includes a multimodal data collection device that uses a digital pen as a primary input mechanism for data and for controlling the device. The digital pen may be connected to the multimodal data collection device through a wired connection, a wireless host connection, or a slave connection. The multimodal data collection device receives data from a number of the I/O devices, captures the data, and then synchronizes selected written, voice and image data with time stamp information and geospatial location information to re-create one or more pre-existing events. In addition, the multimodal data collection device operates to arrange externally and internally received data by synchronizing the data with time and location information. This data may then be stored automatically processed to back end data collection databases. Alternatively stated, the multimodal data collection device may advantageously allow written data, voice, images and geospatial position information for one or more events to be synchronized, stored, and then later be automatically interpreted by back end systems, databases or software applications that operate to update the interpreted information without manual intervention

Some of the data source functions are supported with internal components and software such as a global positioning receiver (GPS), digital paper and pen modules, and audio modules for voice annotation recording and playback. Digital pen input and voice input may both be used to invoke commands for setting up modes of and controlling the multimodal data collection device.

A digital pen and paper system includes a writing surface and a writing utensil in which the utensil knows its location in real time when it is marking on the surface. The writing surface may take the form of a digital tablet or digital paper, for example digital paper made by the Anoto Group AB and having an ANOTO® pattern. Various types of conventional digital pens include, but are not limited to, the MAXELL® digital pen, the NOKIA® digital pen, the LEAPFROG FLYFUSION® digital pen, the ANOTO® digital pen, and the LOGITECH® digital pen. Besides knowledge of placement location, some digital paper systems also maintain records of information like pressure or time as well as various “state” values such as color or width.

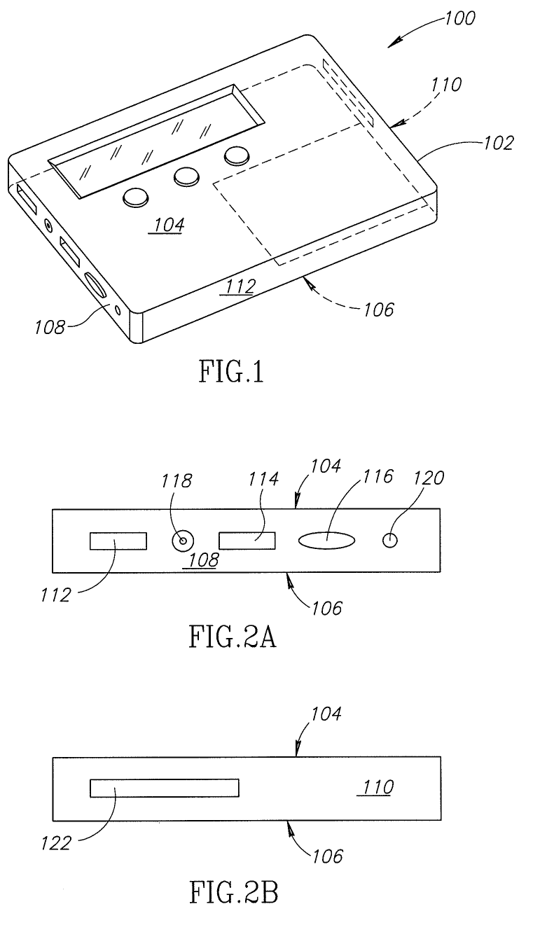

FIG. 1 shows a multimodal data collection device 100 having a body or housing 102 with an upper surface 104, a lower surface 106, a front surface 108, and a back surface 110 according to an illustrated embodiment of the present invention. It is appreciated that the device 100 may take other forms having additional or fewer surfaces depending on ergonomic and aesthetic reasons.

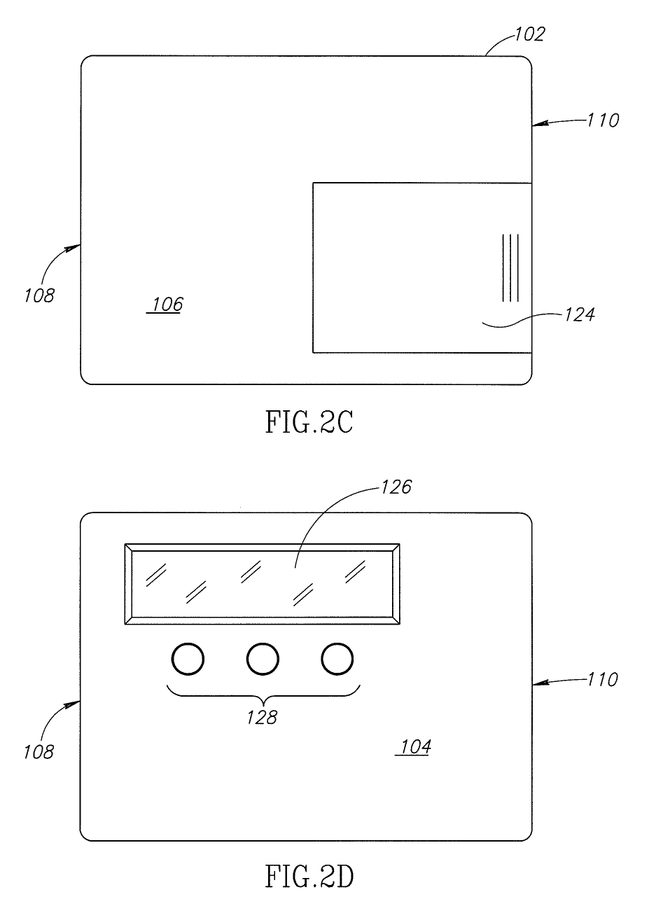

FIGS. 2A-2D show various side elevational views of the multimodal data collection device 100 of FIG. 1. Each of the views is intended to show an example of how selected ports, display screens, slots, power buttons, battery covers, etc. may be arranged with respect to the above-described surfaces of the housing 102. However, it is appreciated and understood this arrangement may be modified in a variety of ways.

FIG. 2A shows a side elevational view of the front surface 108. Arranged on the front surface is a USB host port 112, a USB slave port 114, an ON/OFF button 116, a power indicator light 118, and an audio jack 120. The power indicator light 118 may take the form of a light emitting diode (LED). The purpose of the other ports and jack will be described in greater detail below.

FIG. 2B shows a side elevational view of the rear surface 110 having port 122 for receiving a flash memory card, such as an SDIO flash memory card. FIG. 2C shows the lower surface 106 having a batter cover 124 covering a battery compartment (not shown). FIG. 2D shows the upper surface 104 having a display or readout panel 126 and a plurality of function buttons 128.

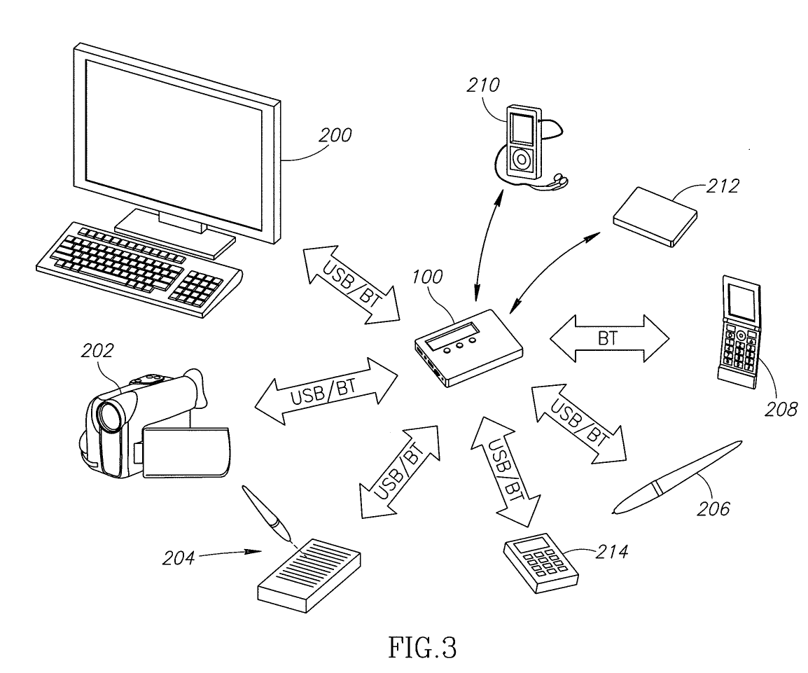

FIG. 3 shows the multimodal data collection device 100 in communication with a number of other devices, which may operate as input devices or external data collection devices. By way of example, the multimodal data collection device 100 may be connected to the number of other devices wirelessly or through one or more wired connections. In the illustrated embodiment, the multimodal data collection device 100 may be connected to a personal computer 200, a digital recording device 202, a scanning device 204 for optically reading symbologies, a digital pen 206, a cellular phone 208, a microphone/headset system 210, a modem 212, and a personal assistant device 214. The number of other devices illustrated are for example purposes only and it is appreciated that additional, fewer or substitute devices may be employed to cooperate with the multimodal data collection device 100.

In the illustrated embodiment, the personal computer 200, the digital recording device 202, the scanning device 204, and the digital pen 206 may communicate with the multimodal data collection device 100 via USB ports, Bluetooth, or an equivalent communication means. Further, the cellular phone 208 may communicate with the multimodal data collection device 100 through a Bluetooth connection while the microphone/headset system 210 connects to the multimodal data collection device 100 through an audio jack port 120 (FIG. 2A).

In addition, there are also a variety of other data collection or communication devices that can add content for data collection using communication channels such as wired and wireless communication interface methods for synchronization and input/output data collection, such as peer to peer, slave or host device communication protocols. The multimodal data collection device 100 provides time stamps and geospatial location data for each of the external device. The overall data package for a given event may be later retrieved and processed from the different, external devices and then integrated into a database and/or processed by various software applications.

In one embodiment, the multimodal data collection device 100 interprets voice audio input commands and records annotation audio data. Additionally or alternatively, the multimodal data collection device 100 may interpret digital pen stroke information as applied to a digital paper pattern.

Further, the multimodal data collection device 100 may continuously or selectively record geospatial information when commanded to by the digital pen or when commanded by the microphone/headset system 210. The multimodal data collection device 100 can receive input from multiple sources and affix time stamps and geospatial location information thereto, thus creating the ability to capture data from an event in which all of or selected amounts of the data may be synchronized and chronologically arranged.

By way of example, the multimodal data collection device 100 augments the capture of synchronized written data with synchronized voice, synchronized images and synchronized geospatial information from either internal components (e.g., GPS module) or from external devices as described above or from other external devices, which may take the form of an application programming interface (API).

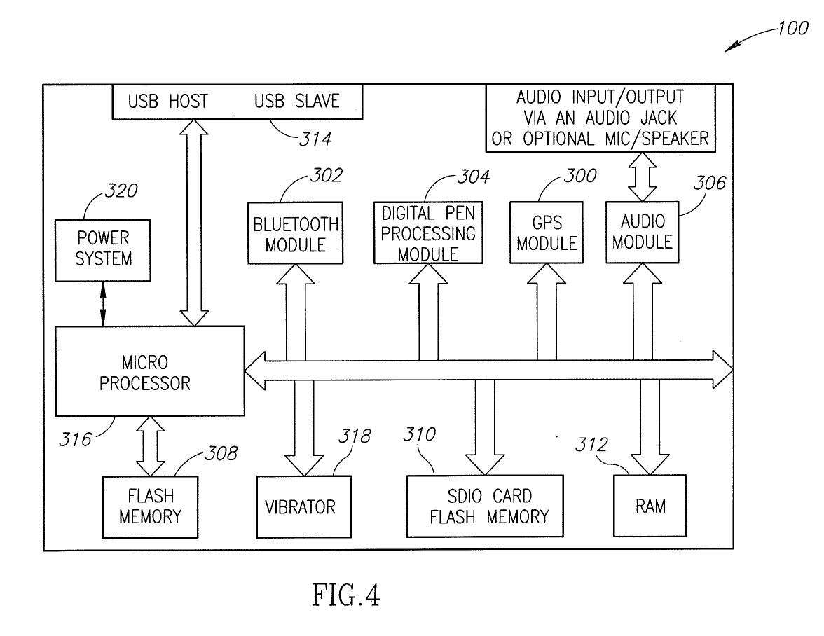

FIG. 4 shows the multimodal data collection device 100 having an internal GPS module 300, a Bluetooth module 302, an internal digital pen processing module or driver 304, an audio module 306 for receiving input from microphone/headset system 210 (FIG. 3), a number of internal flash storage memories 308, 310, a random access memory 312, slave and hosting communication ports 314 for various external devices, a microprocessor or microprocessor unit (MPU) 316 for primary control of the device 100, and a vibrator 318 for haptic user feedback. In the illustrated embodiment, the internal flash storage memory 310 takes the form of a secure digital input/output (SDIO) card for additional data storage capacity. In addition, the device 100 may include replaceable and rechargeable power system 320. By way of example, the plurality of function buttons 128 (FIG. 2D) may be used to operate and control one or more of the internal components of the multimodal data collection device 100.

One advantage purpose of the multimodal data collection device 100 is to synchronize itself and other data collection devices such as, but not limited to, cameras, bar code readers, digital pens, computers, cellular phones, voice input devices, etc. with a time stamp and geospatial location data. Further, the multimodal data collection device 100 may collect data from external and internal devices for storage and subsequently to fully capture a pre-existing event. The multimodal data collection device 100 may receive instructional or operational commands from certain input devices, such as a digital pen, a Bluetooth microphone, and/or a hardwired microphone/headset system.

The multimodal data collection device 100 will also support Bluetooth or other wireless technology. Further, the multimodal data collection device 100 may include speech recognition software to process voice commands as well as voice data recording and retrieval capabilities. The host or slave communication ports allow external device synchronization with the multimodal data collection device 100 as well as data exchange to and from the device 100.

The MPU 316 of the multimodal data collection device 100 may be configured to run a multitude of operating systems such as Windows®, Linux® and a real-time operating system (RTOS).

The GPS module 300 communicates with the MPU 316. A GPS receiver (not shown) of the GPS module 300 may selectively lock onto GPS satellite signals and then store geospatial location information with respective time stamp information to the MPU 316 for storage and later retrieval. Additionally, the GPS module 300 may be employed to generate the time stamp information used to synchronize any external device, whether in wired or wireless communication with the multimodal data collection device 100.

The digital pen processing module or driver 304 may include drivers and software to process data received from the digital pen 206 (FIG. 3). By way of example, the digital pen 206 may be used to write on digital paper, such as Anoto® paper, which includes a digital pattern consisting of small, printed dots having a nominal spacing. The dots may be arranged in a desired grid structure depending on the type or purpose of the digital paper. When writing with a digital pen on the digital paper, digital snapshots of the pattern may be taken automatically at selected intervals. In turn, these digital snapshots may be used to calculate the exact position of the digital pen for that instant in time.

The information generated by the digital pen 206 (FIG. 3) may be processed by the digital pen processing module 304 as command data that is interpreted by the MPU 316 to place the multimodal data collection device 100 in a desired functional state or carry out a desired set of instructions, for example recording GPS information, voice, voice playback, download etc. Further, the digital pen processing module 304 may also interpret the digital pen data in the process of recapturing a desired event.

The device 100 will also be capable of providing users feedback via haptic signals from the vibrator component 318 under software control. Alternately, feedback may also be provided via voice command feedback via pre-stored audio responses from any voice output components available such as internal speaker, wired speaker or a Bluetooth speaker. Additionally another embodiment of this invention may provide visual feedback via a graphical display component of converted speech to text.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. A multimodal data collection device comprising:
a housing having a plurality of connectivity ports to connect the multimodal data collection device with at least one data input/output device located external to the housing;
a microprocessor located within the housing and in communication with at least one memory;
a global positioning system module located within the housing and in communication with the microprocessor, the global positioning system module including a semiconductor chip configured to cooperate with at least one global positioning system software application;
a digital pen processing module located within the housing and in communication with the microprocessor, the digital pen processing module operable to receive and interpret digital pen input from a digital pen and paper system; and
an audio module located within the housing and configured to receive voice commands and annunciate status information regarding the multimodal data collection device, the audio module in communication with the global positioning system module to receive global positioning system information at a commanded interval.

2. The multimodal data collection device of claim 1, further comprising:
a Bluetooth module located within the housing and in communication with the microprocessor, the Bluetooth module operable to receive speech input and provide audio output to a cellular phone.

3. The multimodal data collection device of claim 2, wherein the Bluetooth module interprets voice commands received from a Bluetooth device.

4. The multimodal data collection device of claim 1, further comprising:
a power system located within the housing.

5. The multimodal data collection device of claim 1, wherein the plurality of connectivity ports includes at least one universal serial bus port.

6. The multimodal data collection device of claim 5, wherein the at least one universal serial bus port is a host universal serial bus port.

7. The multimodal data collection device of claim 5, wherein the at least one universal serial bus port is a slave universal serial bus port.

8. The multimodal data collection device of claim 1, wherein the at least one memory includes a flash memory.

9. The multimodal data collection device of claim 1, wherein the at least one memory includes a random access memory.

10. The multimodal data collection device of claim 1, wherein the at least one memory includes a combination of a flash memory and a random access memory.

11. The multimodal data collection device of claim 1, wherein the at least one memory includes an extended non-volatile memory for data storage.

12. The multimodal data collection device of claim 1, further comprising:
a modem configurable to provide wireless communication between the multimodal data collection device and a communication device.

13. The multimodal data collection device of claim 12, wherein the communication device includes a cellular phone.

14. The multimodal data collection device of claim 12, wherein the communication device includes a personal digital assistant device.

15. A method of collecting data using a multimodal data collection device, the method comprising:
receiving data from a plurality of data input/output devices located external to a housing of the multimodal data collection device;
synchronizing the received data with a time and an amount of geospatial information corresponding to when the data was received;
storing the received data; and
using at least some of the stored data to reconstruct an event history for at least one event involving the plurality of data input/output devices.

16. The method of claim 15, further comprising:
providing input from a digital pen, wherein at least some of the input operates to control the multimodal data collection device.

17. The method of claim 15, further comprising:
providing input from an audio transmission device; and
processing the input using an audio module, wherein at least some of the input operates to control the multimodal data collection device located within the multimodal data collection device, and wherein at least some of the input operates to control the multimodal data collection device.

18. The method of claim 15, wherein receiving data from the plurality of data input/output devices includes receiving the data through universal serial bus ports.

19. The method of claim 15, wherein receiving the data from the plurality of data input/output devices includes receiving the data through a wireless modem.

20. The method of claim 19, wherein receiving the data through the wireless modem includes receiving the data from a cellular phone device.

21. The method of claim 19, wherein receiving the data through the wireless modem includes receiving the data from a personal digital assistant device.

22. The method of claim 15, wherein receiving the data from the plurality of data input/output devices includes receiving the data from the group consisting of a digital pen, a digital camera, a personal computer, a video camera; an optical scanning device for reading symbologies; a digital voice recording device, a cellular phone, a personal digital assistant device, and a calculator.

23. The method of claim 15, wherein storing the received data includes storing the received data in a flash memory system.

24. The method of claim 15, wherein storing the received data includes storing the received data in a random access memory system.

25. The method of claim 15, wherein receiving the data from the plurality of data input/output devices includes receiving voice commands from a Bluetooth device and processing the voice commands within the multimodal data collection device using an audio module in communication with a microprocessor.
